(19) United States
(12) Patent Application Publication
(10) Pub. No.: US 2008/0305736 A1
(43) Pub. Date: Dec. 11, 2008

(54) SYSTEMS AND METHODS OF UTILIZING MULTIPLE SATELLITE TRANSPONDERS FOR DATA DISTRIBUTION

(75) Inventors: Celite Milbrandt, Austin, TX (US); John Lane, Austin, TX (US)

Correspondence Address: COOLEY GODWARD KRONISH LLP;ATTN: Patent Group, Suite 1100, 777 - 6th Street, NW, WASHINGTON, DC, 20001, US

(73) Assignee: SLACKER, INC., San Diego, CA (US)

(21) Appl. No.: 12/049,113

(22) Filed: Mar. 14, 2008

Related U.S. Application Data
(60) Provisional application No. 60/894,892, filed on Mar. 14, 2007.

(51) Int. Cl. H04H 20/74

(52) U.S. Cl. 455/3.02

(57) ABSTRACT

Systems and method for providing digital data signals in conjunction with multiple satellite transponders are described. An uplink apparatus is configured to divide and recombine the digital data signal to generate a composite signal. The composite signal is then provided to a satellite and retransmitted by a plurality of satellite transponders to a content receiver. The content receiver is configured to recombine the plurality of transponder signals to regenerate the digital data signal.

### RELATED APPLICATIONS

This application claims priority under 35 U.S.C. § 119(e) to U.S. Provisional Patent Application Ser. No. 60/894,892, entitled SYSTEM AND METHOD FOR UTILIZING MULTIPLE SATELLITE TRANSPONDERS FOR DATA DISTRIBUTION, filed Mar. 14, 2007. This application is related to U.S. Utility patent application Ser. No. 11/955,299, entitled METHOD AND APPARATUS FOR INTERACTIVE DISTRIBUTION OF DIGITAL CONTENT, filed on Dec. 12, 2007, to U.S. Utility patent application Ser. No. 11/923,573, entitled METHODS AND SYSTEMS FOR PERSONALIZED RENDERING OF DIGITAL MEDIA CONTENT, filed on Oct. 24, 2007 and to U.S. Utility patent application Ser. No. 11/923,554, entitled SYSTEMS AND DEVICES FOR PERSONALIZED RENDERING OF DIGITAL MEDIA CONTENT, filed on Oct. 24, 2007. The contents of each of these applications is hereby incorporated by reference herein in its entirety for all purposes.

### FIELD OF THE INVENTION

The present invention relates generally to satellite communication systems. More particularly but not exclusively, the present invention relates to systems and methods for satellite communications using multiple transponders to maximize transponder performance and reduce receiver complexity.

### BACKGROUND OF THE INVENTION

Advances in satellite technology have resulted in the development of transponders having increased transmission power, improved low-noise amplifier (LNA) characteristics, and smaller receiving antennas. As the trend toward higher power transponders continues, existing lower-power transponders have become increasingly available at lower cost.

In existing systems using multiple transponders, it is necessary for the receiver to have multiple antennas and a timing signal to synchronize the signals received from the multiple satellite transponders. Consequently, these receivers are relatively complex and expensive. Therefore, the potential cost savings associated with lower-cost transponders has heretofore been offset by the higher acquisition cost of the receiver unit. Moreover, for portable satellite receivers, it is typically important to have a small receiving antenna and reduced receiver complexity. Using conventional approaches, it is difficult to obtain acceptable signal-to-noise ratios with low power transponders used in conjunction with small receiving antennas. Accordingly, there is a need for alternate approaches to multiple satellite transponder use in conjunction with a simplified receiver design.

### SUMMARY

The present invention is directed generally to systems and methods for providing digital content in conjunction with a satellite having a plurality of transponders.

In one aspect, embodiments of the present invention relate to a content receiver configured to receive a plurality of transponder signals from a satellite and combine the signals to generate a combined signal, the combined signal based on a composite signal provided to the satellite.

In another aspect, embodiments of the present invention relate to an uplink apparatus configured to receive a digital data signal, divide the digital data signal into a plurality of divided signals, and recombine the divided signals to generate a composite signal that may be provided to a satellite for transmission to a content receiver.

In another aspect, embodiments of the present invention relate to a system comprising an uplink apparatus and a content receiver, the uplink apparatus configured to receive a digital data signal, divide the digital data signal into a plurality of divided signals, and recombine the divided signals to generate a composite signal. The composite signal may then be transmitted to a satellite where it may be separated into a plurality of transponder signals, with the transponder signals then transmitted to a content receiver configured to receive the plurality of transponder signals and recombine the transponder signals to regenerate the original digital data signal.

Additional aspects of the present invention are further described and illustrated with respect to the detailed description and figures.

### BRIEF DESCRIPTION OF THE DRAWINGS

The invention is more fully appreciated in connection with the following detailed description taken in conjunction with the accompanying drawings, wherein:

FIG. 1 illustrates a general satellite communication architecture for facilitating embodiments of the present invention.

FIG. 1b is a schematic and circuit block diagram of a satellite uplink apparatus in accordance with an embodiment of the present invention.

FIG. 2 illustrates an embodiment of signals associated with a data division and frequency conversion process in accordance with aspects of the present invention.

FIG. 3a illustrates a satellite and transponder configuration in accordance with aspects of the present invention.

FIG. 3b illustrates an embodiment of signals associated with the satellite and satellite transponder shown in FIG. 3a.

FIG. 4 is a block diagram of a content receiver unit in accordance with an embodiment of the present invention.

FIG. 5 is a block diagram of a content receiver unit in accordance with an embodiment of the present invention.

### DETAILED DESCRIPTION

In the following description reference is made to the accompanying drawings wherein are shown, by way of illustration, several embodiments of the present invention. It is understood by those of ordinary skill in the art that other embodiments may be utilized and structural changes made without departing from the spirit and scope of the present invention. Like elements are marked throughout the specification and the drawings with the same respective reference designators unless indicated otherwise.

Advances is satellite technology have resulted in the development of transponders having increased transmission power, improved low-noise amplifier (LNA) characteristics, and smaller receiving antennas. As the trend toward higher power transponders continues, existing lower-power transponders have become increasingly less expensive to use. The availability of these low-cost satellite communication system presents an opportunity to provide high-throughput, low cost satellite communication systems by combining multiple satellite transponders to transmit data that was previously transmitted over a single transponder.

In existing systems using multiple transponders, it is necessary for the receiver to have multiple antennas and a timing signal to synchronize the signals received from the multiple satellite transponders. Consequently these receivers are relatively complex and expensive. Therefore, the potential cost savings associated with lower-cost transponders has heretofore been offset by the higher acquisition cost of the receiver unit. Moreover, for portable satellite receivers, it is typically important to have a small receiving antenna and reduced receiver complexity. Using conventional approaches, it is difficult to obtain acceptable signal-to-noise ratios with low power transponders used in conjunction with small receiving antennas. As described in further detail below, embodiments of the present invention address these concerns as well as others by facilitating use of multiple satellite transponders in conjunction with a satellite receiver operating at a low signal-to-noise ratio while using a simplified design with fewer components.

In accordance with aspects of the present invention, embodiments provide an improved satellite receiver that can be used in a satellite data transmission system comprising multiple satellite transponders.

In one aspect, embodiments of the present invention relate to an uplink apparatus configured to receive a digital data signal, divide the digital data signal into a plurality of divided signals, and recombine the divided signals to generate a composite signal that may be provided to a satellite for transmission to a content receiver. In one embodiment, digital data is modulated, power divided, and then summed to generate the composite signal. In another embodiment, digital data is modulated, content divided, and then summed to generate the composite signal.

In accordance with another aspect, embodiments of the present invention relate to transmission of the composite signal to a satellite having a plurality of satellite transponders. The composite signal is processed and retransmitted by the transponders to a content receiver.

In accordance with another aspect, embodiments of the present invention relate to a content receiver configured to receive a plurality of transponder signals from a satellite and combine the signals to generate a combined signal, the combined signal based on a composite signal provided to the satellite. In accordance with some embodiments, the plurality of transponder signals results in a higher power level for the combined signal, thereby enabling smaller antennas at the receiver unit and/or enhanced signal characteristics. In addition, the increased power may result in a larger transmission range, increased signal reliability, or increased data rate. The plurality of transponder signals may be received by a single antenna and provided to the content receiver from the antenna, thereby avoiding use of a timing signal. This may provide advantages including allowing use of a single beam antenna rather than a multi-beam antenna, with only one directional antenna required to receive signals from the plurality of satellite transponders. In addition, if a single directional antenna is used, the filtered transponder signals may be closely time-correlated, resulting in processing circuitry in the receiver that is able to combine the content of multiple received transponder signals without the need for memory buffers, a timing signal and/or a controller system.

In accordance with aspects of embodiments of the present invention, significant flexibility in the transmission of data signals using multiple transponders may be provided. For example, in typical embodiments where multiple transponders are receiving and retransmitting the same content, the added transponders may increase the channel's robustness by increasing its power for a faster data rate, increased reliability, and/or a longer transmission range. Embodiments of the invention may also provide greater flexibility for satellite communications by not limiting the communication between the transmitter and receiving units to a specific transponder, since the assignment of transponders may be done arbitrarily. For example, if one satellite becomes inoperable, transponders on another satellite may be used to transmit data using the techniques described herein.

Additional details related to embodiments of the present invention are further described below with respect to the drawings.

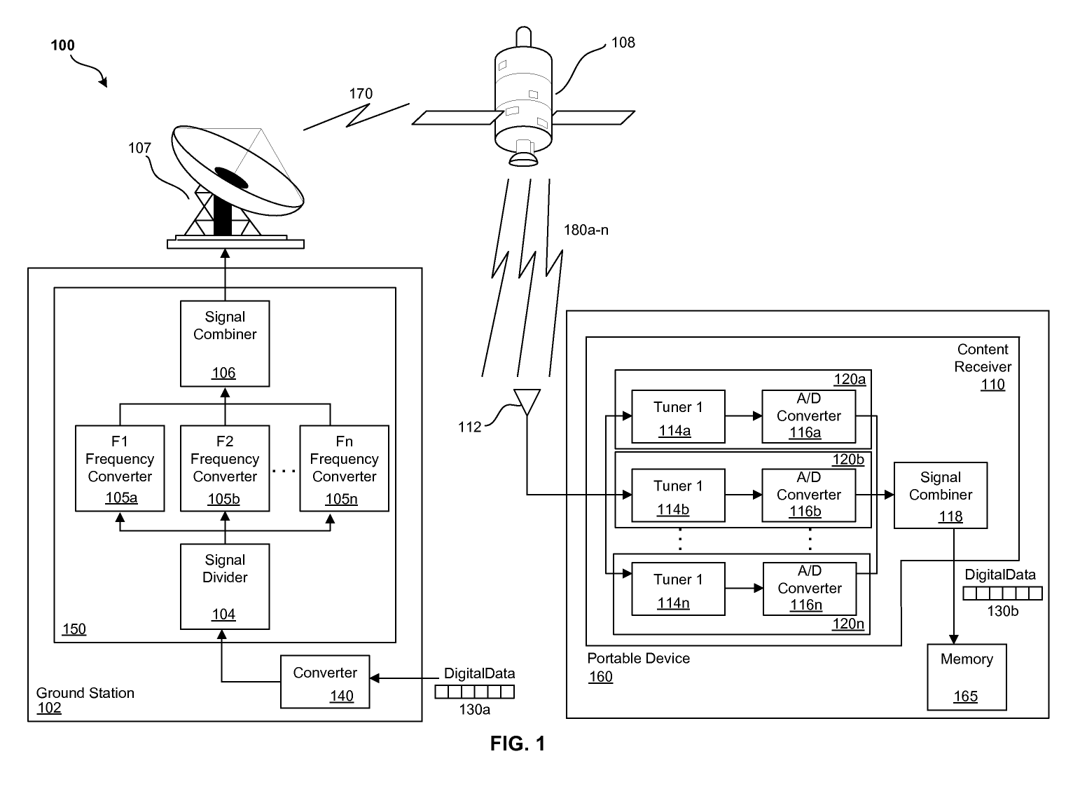

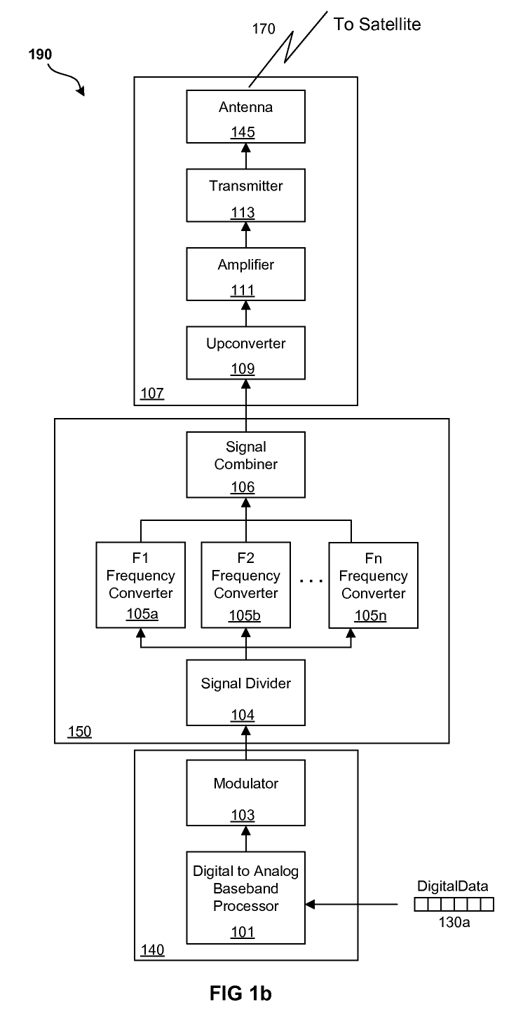

Attention is now directed to FIG. 1 which illustrates an embodiment of a satellite communication system 100 in accordance with the present invention. System 100 includes a composite signal generation module 150, a satellite transmitter 107, a satellite 108 and a content receiver 110. Composite signal generation module 150 may be included in a ground station 102 and may include composite signal generation circuitry, described in greater detail below, that is broadly comprised of a signal divider 104, a plurality of frequency converters 105a-105n, and a signal combiner 106.

Composite signal generation module 150 is configured generally to receive a digital data signal, divide the digital data signal into a plurality of divided signals, and recombine the divided signals to generate as output a composite data signal. The digital data signal is typically based on input digital data 130a, with digital data 130a being a digital data stream, packet, frame or other form of digital data. The digital data signal may be a digital signal in an analog form, such as a modulated digital signal based on digital data 130a. For example, in one embodiment the digital data signal is provided to composite signal generation module 150 from a data converter 140, where data converter 140 receives input baseband digital data 130a and modulates it to a first intermediate frequency (IF), providing the first IF modulated signal to composite signal generator 150.

The composite signal output of composite signal generation module 150 is then provided to satellite transmitter 107, with the transmitted composite signal 170 sent to satellite 108. In typical embodiments transmission of the composite signal may be done using standard satellite transmission techniques such as are known in the art.

As described in greater detail below, satellite 108 comprises a plurality of transponders that are configured to receive the transmitted composite signal 170, extract composite signal components, and retransmit the extracted components, as a plurality of transponder component signals 180a-n, to satellite reception antenna 112 coupled to content receiver 110. Antenna 112 receives the transponder component signals 180a-n nearly simultaneously, since the individual component signals are typically extracted from the composite signal 170 and retransmitted by the satellite transponders at substantially the same time, and provides the transponder component signals to content receiver 110. Content receiver 110, which may be part of a mobile or portable device 160, then processes and recombines the component signals to regenerate the input data signal.

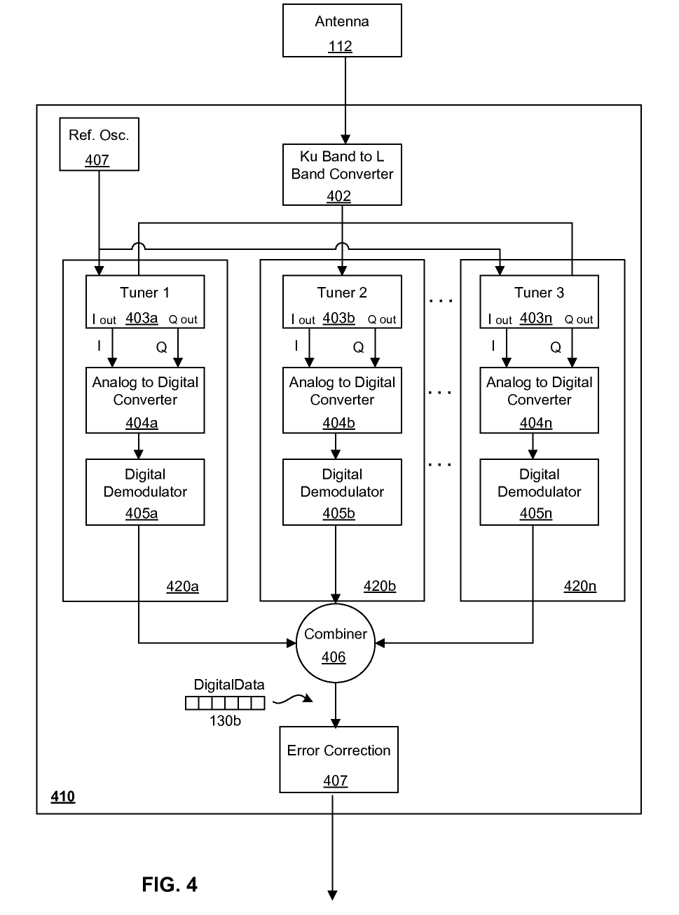

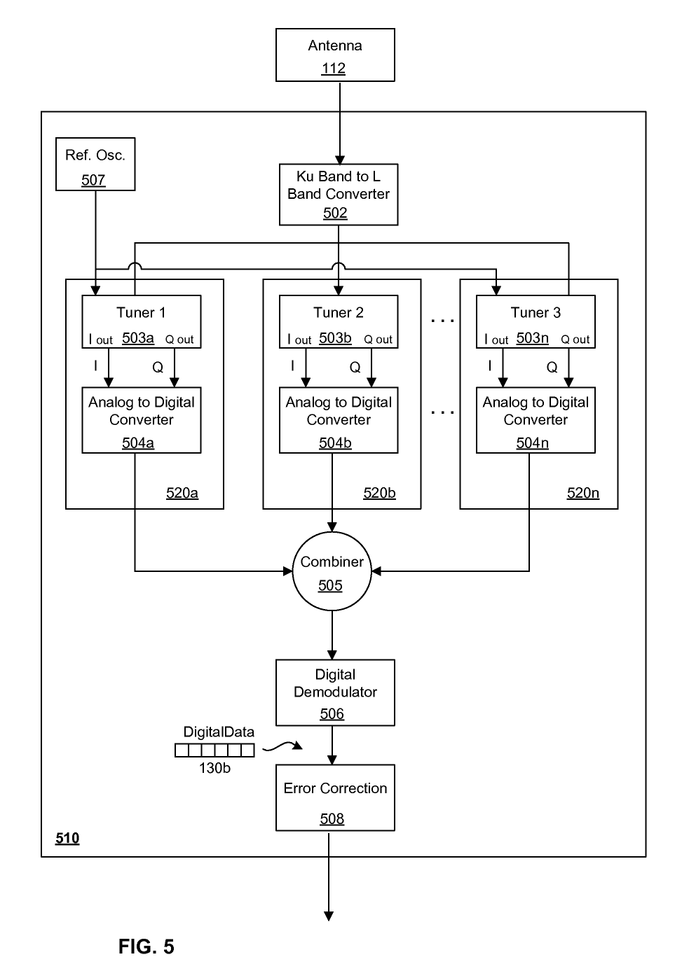

In typical embodiments, content receiver 110 includes a plurality of receiver modules 120a-120n which include a plurality of tuners 114a-114n that extract a baseband analog signal from the received transponder component signals. The baseband analog signals are digitized by a set of analog-to-digital converters 116a-116n and then summed by a signal combiner 118 to regenerate a recombined version 130b of digital data 130a. Recombined digital data 130b may then be provided as output, such as for further processing and/or storage in a memory 165 of portable device 160. Additional details of embodiments of content receivers are described below with respect to FIG. 4 and FIG. 5.

In addition, after being output from content receiver 110, digital data 130b may be further processed and/or rendered, such as is described in further detail in the related applications, to provide audio, video, text, images or other forms of content output. In one embodiment, the output digital data may be used to provide user personalized content as is described in the related applications.

It is noted that portable device 160 as shown in FIG. 1 is not limited to a particular size or configuration but rather may be a portable device, handheld device or other type of device. Moreover, the term portable device 160 is used for purposes of illustration and not limitation. Accordingly, portable device 160 may be configured for portable use, mobile use or, in some embodiments, for stationary use such as in a home or office. For example, content receiver 110 may be a component of a portable device 160 configured for installation in vehicles such as automobiles, trucks, motorcycles or other vehicles and/or may be a component of a handheld device or a stationary device or for use in a home, office or other facilities.

Attention is now directed to FIG. 1b which illustrates details of an uplink transmission system 190 in accordance with aspects of the present invention. The uplink transmission system illustrated in FIG. 1b may be implemented in a facility such as ground station 102 as shown in FIG. 1, and will typically be comprised of a converter module 140, composite signal generation module 150, and satellite transmitter 107.

Input digital data 130a is provided to converter module 140, which includes digital-to-analog baseband processor 101 and modulator 103. In converter module 140, digital-to-analog baseband processor 101 receives digital data 130a and converts the data to an analog baseband signal, which is then provided to modulator 103. The baseband analog signal may then be modulated to a first intermediate frequency (IF) digital signal by modulator 103, such as, for example, at an IF of 70 MHz. The first IF signal may then be provided to signal divider 104, where it may be divided into a plurality of divided signals based on a signal division criteria such as signal power, signal content, or other signal division criteria. In a typical embodiment the divided signals will be a plurality of signals at a modulated frequency such as the first IF frequency.

In accordance with one embodiment implementing power division, each of the plurality of divided signals provided by signal divider module 104 may contain the same information at the same data or symbol rate, but with a proportionate fraction of the power of the input signal.

In another embodiment implementing content division, the first IF modulated signal is divided into a plurality of divided signals whereby each divided signal is provided at a lower data rate than the input data signal 130a, with each divided signal having some portion of the data of the input data signal. The divided signals will typically have the same power as the input signal. In some embodiments, the divided signals each carry a mutually exclusive portion of the data in the input data 130a, with the power of each of the divided signals being the same as the input signal. In these embodiments content division can be performed based on bit-by-bit data division, division by data packets, division by data frames, or by other data division criteria.

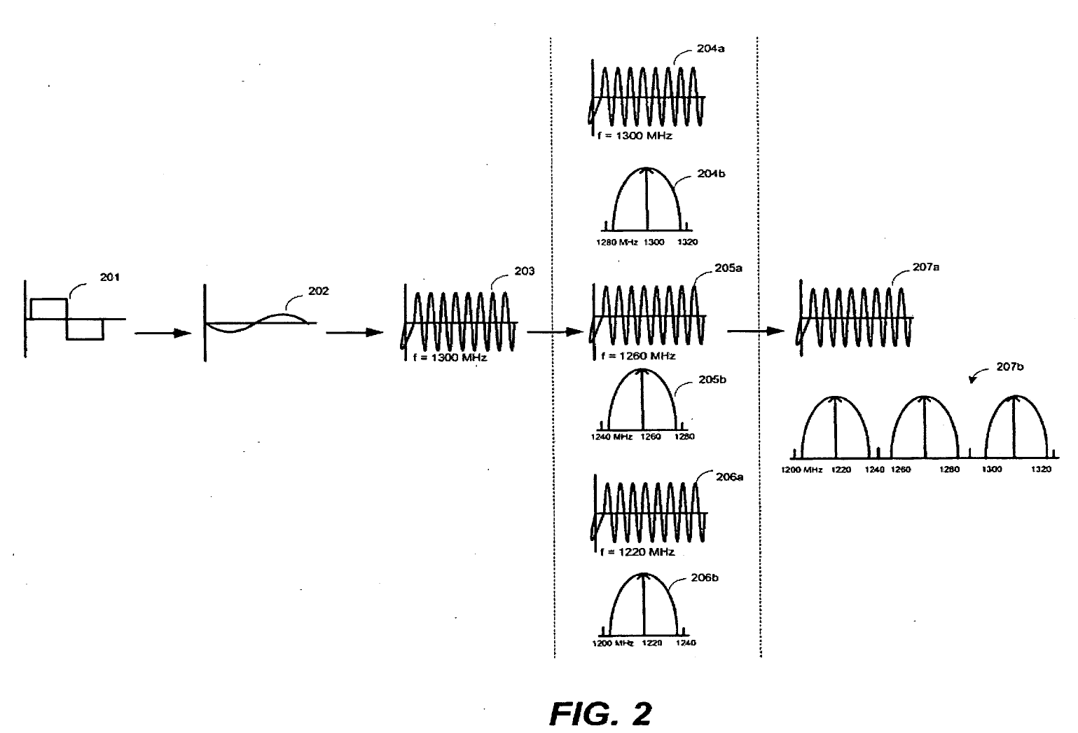

In either of the power or content division embodiments, as well as in others, the divided signals provided by signal divider 104 may be then be recombined in signal combiner 106. In a typical embodiment, the divided signals are provided to a plurality of frequency converters 105a-105n as shown in FIG. 1b to be converted to various carrier frequencies. In a typical embodiment the signals are converted by frequency converters 105a-105n to a plurality of second intermediate frequency modulated signals so that their spectra are non-overlapping. The signals may then be additively combined in signal combiner 106 to create a composite signal including the various divided signals. This may be implemented as further illustrated in FIG. 2, which depicts the various signals being combined in a frequency division multiplexed composite signal in accordance with one embodiment.

The composite signal may then be provided to satellite transmitter 107 which may comprise an upconverter 109, an amplifier 111, a transmitter 113 and an associated transmit antenna 145. The composite signal may be upconverted in upconverter 109, provided to amplifier 111 for any additional desired amplification, and then provided to transmitter 113 and associated antenna 145 for transmission as composite signal 170 to satellite 108.

It is noted that the above provided description of the uplink apparatus does not necessarily have to be performed in the specific order described or with the described components—other signal division, recombination, upconversion and signal transmission methods may alternately be used within the spirit and scope of the present invention. For example, in some embodiments other data division and combining apparatus may be used. In some embodiments digital data 130a may be divided at baseband and then upconverted directly to the plurality of second intermediate frequency signals before recombining. Moreover, the composite signal does not necessarily need to comprise a frequency division multiplexed signal—other signal combination methods may alternately be used in some embodiments. Other components may also be interchanged or reconfigured. For example, in some embodiments the digital-to-analog converter may be configured subsequent to the signal division stage in the processing chain. Further, the upconversion depicted is illustrative of an upconversion to the Ku-band (11.7 GHz to 14.5 GHz) or the C-band (3.7 GHz to 6.425 GHz) based on their common use in satellite communications. However, embodiments of the present invention are not limited to a specific frequency band, and other operating bands and corresponding upconversion methods and apparatus may equally be used.

Attention is now directed to FIG. 2 which illustrates aspects of an embodiment of signal processing that may occur within embodiments of uplink transmission system 190 as shown in FIG. 1b. Visual representations 201-207 are illustrations of time or frequency domain representations of the various signals as processed by the uplink transmission system 190. It is noted that the various representations illustrate particular signal characteristics of one embodiment of signals as they are received and processed by one embodiment of the upconverter; however, other signal configurations may also be used. For example, while representation 201 illustrates the incoming digital data as a bipolar data signal, it is understood that the data is not so limited and various other digital signaling techniques as are known in the art may alternately be use. Likewise, other modulation and/or frequency conversion signaling and associated signal processing may alternately be used.

At the start of the signal processing represented by FIG. 2, digital data 130a may be provided to the converter module 140 for processing. Representation 201 is a time domain representation of a baseband version of such digital data 130a, which is converted by baseband processor 101 to an analog form as shown in representation 202. The analog signal may then be modulated to a first intermediate carrier frequency by modulator 103, as illustrated by representation 203. In representation 203 the analog data signal is modulated to a first IF carrier frequency of 1300 MHz (1.3 GHz), however, other IF frequencies can be used. The IF signal illustrated by representation 203 may then be split by signal divider 104 to generate a plurality of segmented second IF modulated signals as illustrated by visual representations 204a-206a, which illustrate time domain signals. In one embodiment the segmented IF modulated signals are centered at 40 MHz intervals in the frequency domain and are 36 MHz wide, with carrier frequencies at 1.3, 1.26 and 1.22 GHz, respectively, as illustrated by corresponding frequency domain visual representations 204b-206b. The segmented second IF signals are then combined by signal combiner 106 to generate a composite signal illustrated generally by visual representation 207a. In accordance with one embodiment as shown in visual representation 207b, the spectra of the various signals are separated in frequency so that there is no overlap of the spectra of the individual segmented IF signals in the composite signal.

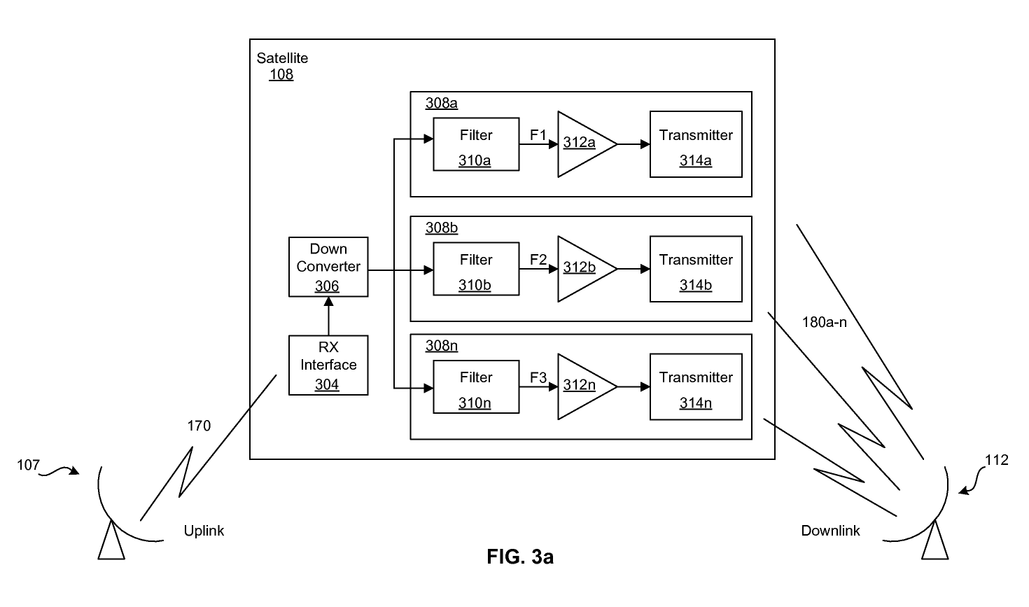

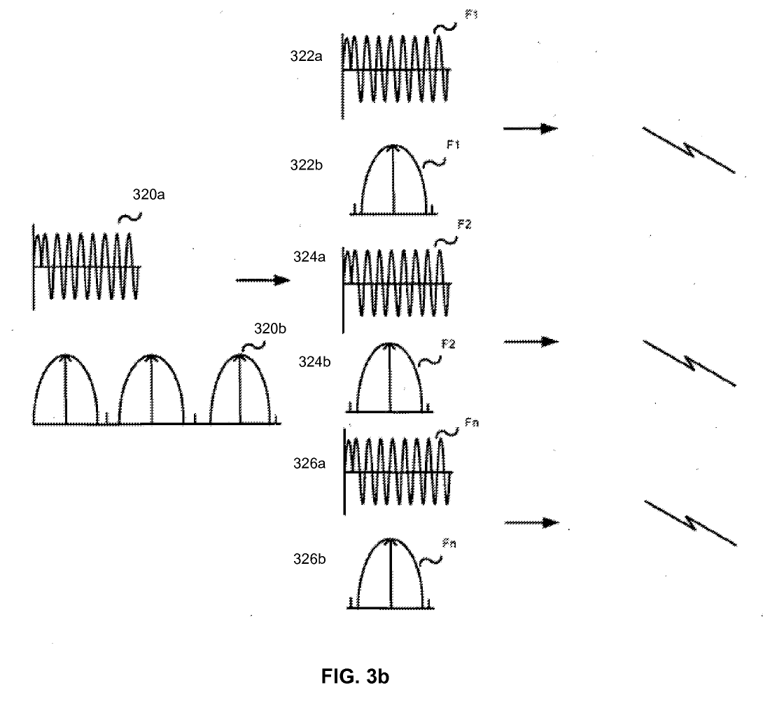

Attention is now directed to FIGS. 3a and 3b which respectively illustrate an embodiment of satellite 108 and various signals processed by satellite 108. As shown in FIG. 3a, satellite 108 includes a receiver interface 304, a downconverter 306, along with a plurality of transponders 308a-308n. FIG. 3b shows visual representations of time and frequency domain signals 320-326 associated with signal processing performed by satellite 108 in accordance with one embodiment of the invention.

The composite signal generated by composite signal generation module 150 may be sent from satellite transmitter 107 as composite signal 170 and received at the receive (RX) interface 304 of satellite 108 via one or more antennas (not shown). The composite signal may then be downconverted by downconverter 306 to a composite satellite IF signal as illustrated in visual representations 320a and 320b of FIG. 3b, with representation 320b showing the non-overlapping spectra of the various segmented signals IF signals in accordance with one embodiment. The downconverted composite signal may then be provided to a plurality of transponders 308a-308n, with each transponder then processing and re-transmitting part of the composite signal. More specifically, in typical embodiments each transponder 308a-308n may include a plurality of filters 310a-310n to extract a plurality of IF signals F1-Fn. In an embodiment implementing power division as described previously, each filtered IF signal F1-Fn carries identical information at the same symbol rate. In another embodiment implementing content division as described previously, each filtered signal F1-Fn is at a lower data rate than the original digital data 130a, with the filtered signals F1-Fn typically carrying mutually exclusive portions of the original digital data 130a. The plurality of transponders may then amplify the respective signals F1-Fn in a plurality of amplifier stages 312a-312n, and transmit the amplified signals in a plurality of transmitters 314a-314n, via a plurality of antennas (not shown), as transponder signals 180a-n for downlink reception at a content receiver as further described below with respect to FIG. 4 and FIG. 5.

Although typical embodiments of the present invention will comprise multiple transponders on a single satellite, in some embodiments multiple transponders on two or more satellites may alternately be used. In addition, while typical embodiments will comprise a satellite configured to implement the functionality described above, in some embodiments other communication technologies configured to receive a composite signal and separate and retransmit the composite signal as a plurality of component signals to a component receiver may alternately be used.

Attention is now directed to embodiments of content receivers configured to receive and process the plurality of transponder signals in accordance with aspects of the present invention. FIG. 4 is a block diagram of a content receiver 410 configured to operate with embodiments of systems of the present invention implementing content division as described previously. Content receiver 410 may be one embodiment of content receiver 110 as shown in FIG. 1. In a typical embodiment content receiver 410 includes a frequency converter 402, a plurality of receiver modules 420a-n, and a combiner module 406. Receiver 410 may also include an error correction module 407 and a reference oscillator 407.

Antenna 112 receives the plurality of signals from a satellite, such as transponder signals 180a-n from satellite transponders 308a-n illustrated in FIG. 3a, typically at substantially the same time, where they may be downconverted at converter 402 to IF signals for further processing. Converter 402 may be configured to downconvert the plurality of signals from the Ku to L band in some embodiments, however, other downconversions may also be implemented. In some embodiments the downconverter may be a low-noise block downconverter including a low noise amplifier (LNA). The downconverted signals may then be applied to a plurality of receiver modules 420a-n, where they may be further processed.

In one embodiment, receiver modules 420a-n each include a tuner module 403a-n, an analog to digital converter module 404a-n, and a digital demodulator 405a-n. The tuner modules may be configured as shown in FIG. 4 to receive the dowconverted output from converter 402 along with a reference signal from reference oscillator 407 and generate in-phase (I) and quadrature (Q) signals for further processing at the analog to digital converters 404a-n.

Analog to digital converters 404a-n then receive the I and Q signals and convert the signals to digitized signals. The digitized signals may then be digitally demodulated at digital demodulators 405a-n to filter out any signal by-products from the previous signal processing and to improve the signal-to-noise ratio. In a content division embodiment the signals will typically be provided at a lower data rate than the original digital data signal 130a. For example, if the original data signal 130a is divided into two components at the signal divider 104, each of the receiver module output signals would be provided at half the data rate of the original data signal 130a.

The signals may then be combined at combiner 406 to recreate the original digital data as regenerated digital data 130b. Combiner 406 will typically including interface circuitry to interface to the plurality of receiver modules 420a-n as well as a combiner circuit to combine the plurality of receiver signals so as to generate as an output digital data 130b. In some embodiments the combiner circuit comprises an adder circuit configured to sum the receiver 420a-n outputs to generate digital data 130b. Digital data 130b may then be further processed, stored, and/or rendered, such as on portable device 160. In addition, the output data 130b may be further applied to an error correction module 407 to further improve the signal quality, and the error-corrected version of digital data 130b may then be provided for further processing and/or storage in a memory of portable device 160, such as memory 165.

FIG. 5 is a block diagram of another embodiment of a content receiver 510 configured to operate in embodiments of the system of the present invention implementing power division as described previously. Content receiver 510 may be one embodiment of content receiver 110 as shown in FIG. 1. In a typical embodiment content receiver 510 includes a frequency converter 502, a plurality of receiver modules 520a-n, a combiner module 505 and a digital demodulator module 506. Receiver 510 may also include an error correction module 508 and a reference oscillator 507.

Antenna 112 receives the plurality of signals from a satellite, such as signals 180a-n from satellite transponders 308a-n illustrated in FIG. 3a, where they may be downconverted at converter 502 to IF signals for further processing. Converter 502 may be configured to downconvert the plurality of signals from the Ku to L band in some embodiments, however, other downconversions may also be implemented. In some embodiments the downconverter may be a low-noise block downconverter including a low noise amplifier (LNA). The downconverted signals may then be applied to a plurality of receiver modules 520a-n, where they may be further processed.

In one embodiment, receiver modules 520a-n each include a tuner module 503a-n and an analog to digital converter module 504a-n. The tuner modules may be configured as shown in FIG. 5 to receive the downconverted output from converter 502 along with a reference signal from reference oscillator 507 and generate I and Q signals for further processing at the analog to digital converters 504a-n.

Analog to digital converters 504a-n then receive the I and Q signals and convert the signals to digitized signals. The digitized signals may then be combined at combiner 505 to generate a combined receiver output signal, the combined receiver output signal typically having a higher signal to noise ratio. The combiner 505 typically including interface circuitry to interface to the plurality of receiver modules 420a-n as well as a combiner circuit to combine the plurality of receiver output signals so as to generate the combined output signal. In some embodiments the combiner circuit comprises an adder circuit configured to sum the receiver 520a-n outputs to generate the combined receiver output signal, which will typically be an undemodulated signal in power division embodiments.

The combined output signal may then be applied to digital demodulator 506 to recreate the original digital data 130a as regenerated digital data 130b, which may then be further processed, stored, and/or rendered on portable device 160. In addition, digital data 130b may be further applied to an error correction module 508 to further improve the signal quality, with the error-corrected version of digital data 130b then provided as output for further processing and/or storage in a memory of portable device 160, such as memory 165.

The foregoing description, for purposes of explanation, used specific nomenclature to provide a thorough understanding of the invention. However, it is apparent to one of ordinary skill in the art that specific details are not required in order to practice the invention. Thus, the foregoing descriptions of specific embodiments of the invention are presented for purposes of illustration and description, not limitation. They are not intended to be exhaustive or to limit the invention to the precise forms disclosed; obviously, many modifications and variations are possible in view of the above teachings. Consequently, variations and modifications of the embodiments disclosed herein may be made without departing from the spirit and scope of the invention as set forth by the claims.

The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

I claim:

1. A content receiver, comprising:
a plurality of receiver modules, wherein each of the plurality of receiver modules is configured to receive one of a plurality of component satellite transponder signals generated from a composite signal; and
a combiner module configured to provide a combined output signal based upon a plurality of output signals generated by the plurality of receiver modules.

2. The content receiver of claim 1 further comprising an error correction module coupled to the combiner module.

3. The content receiver of claim 1 wherein each of the plurality of receiver modules comprises:
a tuner;
an analog-to-digital converter coupled to the tuner; and
a digital demodulator coupled to the analog-to-digital converter.

4. The content receiver of claim 3 wherein the combiner module comprises a combiner circuit configured to:
receive the plurality of output signals from the receiver modules, the plurality of output signals comprising digital demodulated data signals; and
combine the plurality of digital demodulated data signals to generate the combined output signal.

5. The content receiver of claim 1 wherein each of the plurality of receiver modules comprises:
a tuner module; and
an analog-to-digital converter coupled to the tuner module.

6. The content receiver of claim 5 wherein the combiner module comprises a combiner circuit configured to:
receive the plurality of output signals from the receiver modules, the plurality of output signals comprising undemodulated signals; and
combine the plurality of undemodulated signals to generate the combined output signal.

7. The content receiver of claim 6 further comprising a digital demodulator coupled to the combiner module to receive the combined output signal and provide a demodulated combined output signal.

8. The content receiver of claim 7 further comprising an error correction module coupled to the digital demodulator.

9. A method, comprising:
receiving a plurality of satellite transponder signals, said plurality of satellite transponder signals being generated from a composite signal;
providing a corresponding plurality of output signals; and
combining the plurality of output signals to generate a combined output signal.

10. The method of claim 9 wherein the providing a corresponding plurality of output signals comprises:
converting the plurality of transponder signals to a corresponding plurality of analog received signals;
converting the plurality of analog received signals to a corresponding plurality of digitized received signals; and
demodulating the plurality of digitized received signals to generate the plurality of output signals.

11. The method of claim 10 wherein the combined output signal comprises a demodulated signal.

12. The method of claim 11 further comprising error correcting the combined output signal.

13. The method of claim 9 wherein the providing a corresponding plurality of output signals comprises:
converting the plurality of transponder signals to a corresponding plurality of analog received signals; and
converting the plurality of analog received signals to a corresponding plurality of digitized received signals.

14. The method of claim 13 wherein the combined output signal is an undemodulated signal.

15. The method of claim 14 further comprising demodulating the combined output signal to generate a demodulated combined output signal.

16. The method of claim 15 further comprising error correcting the demodulated combined output signal.

17. An uplink system for providing a composite signal for transmission to satellite, comprising:
a signal divider module configured to receive a first digital data signal and provide a plurality of divided signals;
a plurality of frequency converters configured to receive the plurality of divided signals and generate a corresponding plurality of second intermediate frequency divided signals; and
a signal combiner module configured to receive the plurality of second intermediate frequency divided signals and generate the composite signal.

18. The system of claim 17 wherein the signal divider module is configured to divide signal power of the first digital data signal among the divided signals.

19. The system of claim 18 wherein the divided signals are provided at a lower power level than the first digital data signal.

20. The system of claim 17 wherein the signal divider module is configured to divide signal content of the first digital data signal among the divided signals.

21. The system of claim 20 wherein the divided signals are provided at a lower data rate than the first digital data signal.

22. The system of claim 21 wherein the data content of ones of the plurality of divided signals is mutually exclusive.

23. The system of claim 17 wherein the plurality of frequency converters are configured to generate the ones of the plurality of second intermediate frequency divided signals in a plurality of frequency bands.

24. The system of claim 23 wherein the plurality of second intermediate frequency divided signals have non-overlapping spectra.

25. The system of claim 17 further comprising:
a digital-to-analog converter configured to receive an input digital data signal and provide an analog data signal; and
a modulator configured to receive the analog data signal and modulate the analog signal to provide the first digital data signal.

26. A method of providing a composite signal for satellite transmission comprising:
receiving a first digital data signal;
generating, based on the first digital data signal, a plurality of divided signals;
converting the plurality of divided signals into a corresponding plurality of second intermediate frequency divided signals; and
combining the second intermediate frequency divided signals to generate a composite signal.

27. The method of claim 26 wherein the plurality of divided signals are generated based on signal power.

28. The method of claim 26 wherein the plurality of divided signals are generated based on signal content.

29. The method of claim 28 wherein the signal content of ones of the plurality of divided signals is mutually exclusive.

30. The method of claim 26 wherein the plurality of second intermediate frequency divided signals are provided in a plurality of frequency bands.

31. The method of claim 30 wherein the plurality of second intermediate frequency divided signals have non-overlapping spectra.

32. The method of claim 36 further comprising:
receiving an input digital data signal;
providing an analog data signal based on the input digital data signal; and
modulating the analog data signal to generate the first digital data signal.

33. A system for providing digital content in conjunction with a plurality of satellite transponders of a satellite, the system comprising:
An uplink system including:
a signal divider module configured to receive a first digital data signal and provide a plurality of divided signals;
a plurality of frequency converters configured to receive the plurality divided signals and generate a corresponding plurality of second intermediate frequency divided signals;
a signal combiner module configured to receive the plurality of second intermediate frequency divided signals and generate a composite signal for provision to the satellite; and
a content receiver configured to provide a combined output signal based upon a plurality of component transponder signals received from the satellite.

34. The system of claim 33 wherein the content receiver includes:
a plurality of receiver modules, each of the receiver modules being configured to:
receive the plurality of transponder signals from the satellite, said plurality of transponder signals generated from the composite signal provided to the satellite; and
provide ones of a corresponding plurality of output signals; and
a combiner module configured to combine the plurality of output signals to provide the combined output signal.

35. A method of providing a digital data signal to a content receiver comprising:
providing, to a satellite, a composite signal derived from a first digital data signal;
receiving, from the satellite, a plurality of transponder signals generated from the composite signal;
providing a corresponding plurality of output signals; and
combining the plurality of output signals to regenerate the first digital data signal.

36. The method of claim 35 further including:
receiving the first digital data signal at an uplink apparatus;
generating, based on the first digital data signal, a plurality of divided signals;
converting the plurality of divided signals into a corresponding plurality of intermediate frequency divided signals; and
combining the intermediate frequency divided signals to generate the composite signal.
